(19) United States
(12) Patent Application Publication
(10) Pub. No.: US 2011/0244274 A1
(43) Pub. Date: Oct. 6, 2011

(54) BATTERY PACKS

(75) Inventors: Kazutoshi OGINO, Anjo-shi (JP); Hideyuki TAGA, Anjo-shi (JP)

(73) Assignee: MAKITA CORPORATION, Anjo-shi (JP)

(21) Appl. No.: 13/079,215

(22) Filed: Apr. 4, 2011

(30) Foreign Application Priority Data
Apr. 6, 2010 (JP) 2010-087633

(51) Int. Cl. H01M 10/42

(52) U.S. Cl. 429/7

(57) ABSTRACT

A battery pack includes a circuit board and a battery cell group disposed within a battery case. The battery cell group includes a plurality of cylindrical battery cells staggered from each other so that the battery cell group includes at least a first battery cell stage and a second battery cell stage. The first battery cell stage is positioned on the side of the circuit board. The second battery cell stage is positioned adjacent to the first stage on the side away from the circuit board. The first battery cell stage includes a first battery cell and a second battery cell positioned at opposite ends of the first battery cell stage and a central battery cell positioned between the first and the second battery cell. The central battery cell is spaced from the circuit board by a distance, so that the central battery cell does not interfere with the circuit elements of the circuit board.

This application claims priority to Japanese patent application serial number 2010-87633, the contents of which are incorporated herein by reference.

The present invention relates to battery packs that may be used, for example, for power tools.

### DESCRIPTION OF THE RELATED ART

A known battery pack is disclosed, for example, in US2008/0152993. FIG. 13 shows a cross sectional view corresponding to FIG. 1a of this publication.

As shown in FIG. 13, a known battery pack 200 includes a battery case 150, a circuit board 140 disposed within the battery case 150 and having circuit elements 160 and 162 mounted thereon, and ten tired cylindrical battery cells 110, 112, 114, 116, 118, 120, 122, 124, 126 and 168 disposed within the battery case 150. Three battery cells 110, 112 and 114 positioned at the top stage of the ten battery cells are positioned on the side of the backside surface 144 a surface on the side of the circuit elements) of the circuit board 140.

In the case of the above known battery pack 200, valley-like spaces are defined between the left side battery cell 110 and the central battery cell 112 positioned on the side of the circuit board 140 and between the central battery cell 112 and the right side battery cell 114 also positioned one the side of the circuit board 140. These valley-like spaces are used as mounting spaces for mounting the circuit elements 160 and 162. However, because of the presence of the central battery cell 112 of the battery cells 110, 112 and 114, a total space usable for mounting circuit elements on the circuit board 140 is reduced. In other words, an area of the circuit board 140 usable for mounting the circuit elements is reduced.

Therefore, there is a need in the art for a battery pack that can increase an area of a circuit board usable for mounting circuit elements.

### SUMMARY OF THE INVENTION

According to the present teaching, a battery pack includes a circuit board and a battery cell group disposed within a battery case. The battery cell group includes a plurality of cylindrical battery cells staggered from each other so that the battery cell group includes at least a first battery cell stage and a second battery cell stage. The first battery cell stage is positioned on the side of the circuit board. The second battery cell stage is positioned adjacent to the first stage on the side away from the circuit board. The first battery cell stage includes a first battery cell and a second battery cell positioned at opposite ends of the first battery cell stage and a central battery cell positioned between the first and the second battery cell. The central battery cell is spaced from the circuit board by a distance, so that the central battery cell does not interfere with the circuit elements of the circuit board.

### BRIEF DESCRIPTION OF THE DRAWINGS

FIG. 1 is a perspective view of a battery pack according to a first example;

FIG. 2 is a sectional view as viewed from a front side of the battery pack;

FIG. 3 is a perspective view of the battery pack with a part cut-out;

FIG. 4 is a perspective view of he battery pack with a cover member of a battery case removed;

FIG. 5 is a perspective view of one of battery cells of the battery pack;

FIG. 6 is a schematic explanatory view showing an arrangement of the battery cells and a circuit board of the battery pack;

FIG. 7 is a view similar to FIG. 6 but showing an arrangement of battery cells and a circuit board of a battery pack according to a first comparative example;

FIG. 8 is a view similar to FIG. 6 but showing an arrangement of battery cells and a circuit board of a battery pack according to a second comparative example;

FIG. 9 is a view similar to FIG. 6 but showing an arrangement of battery cells and a circuit board of a battery pack according to a third comparative example;

FIG. 10 is a view similar to FIG. 6 but showing an arrangement of battery cells and a circuit board of a battery pack according to a fourth comparative example;

FIG. 11 is a view similar to FIG. 6 but showing an arrangement of battery cells and a circuit board of a battery pack according to a second example;

FIG. 12 is a view similar to FIG. 6 but showing an arrangement of battery cells and a circuit board of a battery pack according to a third example; and

FIG. 13 is a vertical sectional view of a known battery pack.

### DETAILED DESCRIPTION OF THE INVENTION

Each of the additional features and teachings disclosed above and below may be utilized separately or in conjunction with other features and teachings to provide improved battery packs. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one example, a battery pack includes a battery case, a circuit board disposed within the battery case and having circuit elements mounted thereon, and a battery cell group including a plurality of cylindrical battery cells having a same radius and diameter and disposed within the circuit board. The battery cells are staggered from each other so that the battery cell group has a plurality of battery cell stages including a first battery cell stage positioned on the side of the circuit elements of the circuit board and a second battery cell stage positioned adjacent to the first stage on the side away from the circuit board. The first battery cell stage includes at least three battery cells including a first battery cell, a second battery cell and a third battery cell. The first and second battery cells are positioned at opposite ends of the first battery cell stage. Third battery cell is positioned between the first and the second battery cell. The third battery cell is displaced in a direction away from the circuit board relative to the first and second battery cells by a distance smaller than the radius of the battery cells.

With this arrangement, it is possible to increase an area of the circuit board usable for mounting the circuit elements without accompanying substantial increase of the size of the battery pack.

For example, the first battery cell stage includes three battery cells and the second battery cell stage includes two battery cells, so that the battery cell group includes five battery cells in total. At least one of the first and second battery cell stages may include one or more additional battery cells, so that the battery cell group includes six or more battery cells in total.

The battery case may include a bottom wall and first and second side walls opposite to each other. An inwardly oriented concave portion may be formed at each of corner portions between the bottom wall and the first and second side walls. With this arrangement, the width of the bottom wall of the battery case can be reduced and therefore, it is possible to further reduce the size of the battery pack.

The battery cells may be tired such that each of the battery cells in the first battery cell stage directly contacts the corresponding battery cell(s) in the second battery cell stage. Alternatively, the battery cells may be tired such that each of the battery cells in the first battery cell stage does not directly contact the corresponding battery cell(s) in the second battery cell stage. For example, a cell holder may hold the battery cells so that the battery cells do not contact with each other.

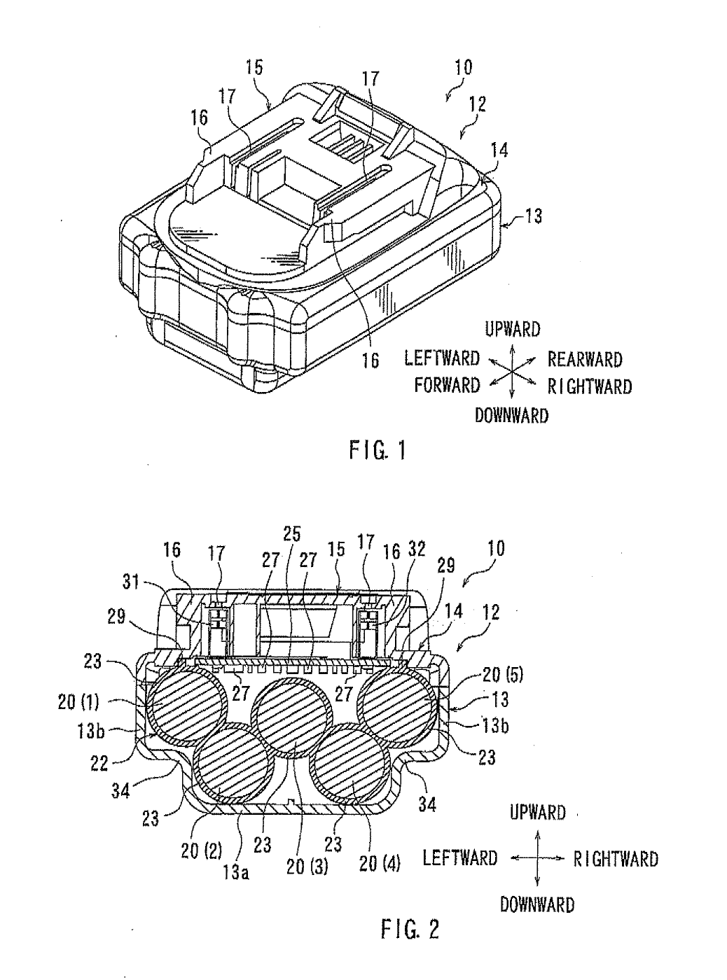

A first example will be now described with reference to FIGS. 1 to 6. First, a general construction of a battery pack 10 will be described, The battery pack 10 shown in FIGS. 1 to 4 can be used for a hand-held power tool, such as a power screwdriver and a power drill (not shown). A battery charger (not shown) can recharge the battery pack 10 so that the battery pack 10 can be repeatedly used. In order to mount the battery pack 10 to the power tool or the battery pack, the battery pack 10 is slid forwardly relative to a mounting portion of the power tool or the battery pack. On the other hand, in order to remove the battery pack 10 from the power tool or the battery pack, the battery pack 10 is slid rearwardly relative to the mounting portion.

As shown in FIG. 1, the battery pack 10 includes a battery case 12 having a box-like configuration elongated in forward and rearward directions. The battery case 12 may be made of resin. The battery case 12 includes a case body 13 and a cove member 14. The case body 13 has a configuration like a box having a bottom and an open top, The cover member 14 is mounted to the case body 13 for covering the open top of the case body 13. The cover member 14 has a mounting portion 15 on its upper portion for mounting to a power tool or a battery charger. A pair of right and left guide rails 16 are formed on the mounting portion 15 and extend in forward and rearward directions (see FIG. 2). Slits 17 each having front and upper openings are formed in the mounting portion 15 at positions inwardly of the guide rails 16.

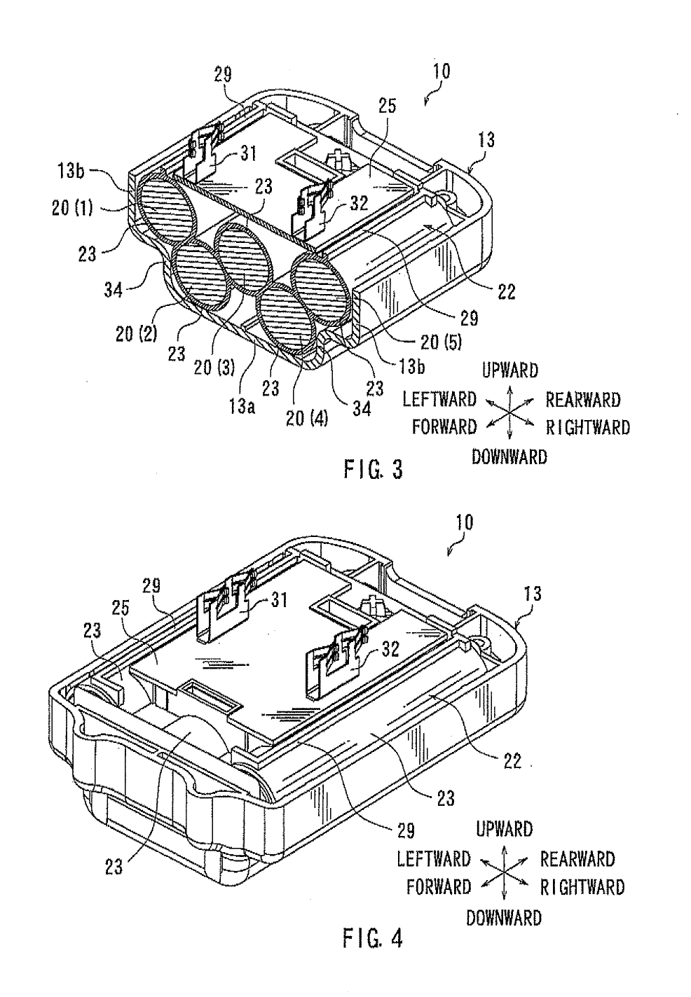

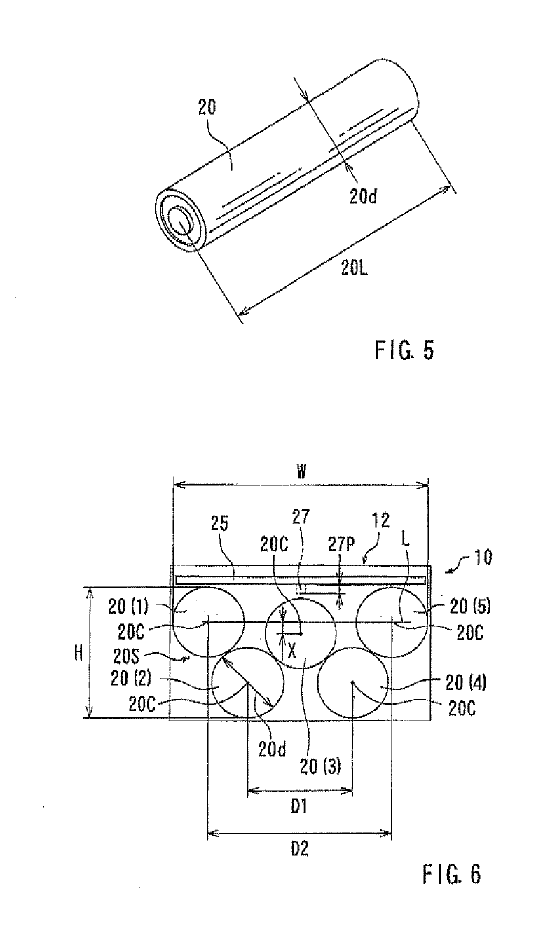

As shown in FIG. 2, a plurality of battery cells 20 (five in this example) are stored within the case body 13 and are supported by a cell holder 22 (see FIG. 3). As shown in FIG. 5, each of the battery cells 20 has a cylindrical configuration having a diameter 20d and an axial length 20L. In this example, the diameter 20d is set to be 18 mm and the axial length 20L is set to be 75 mm.

The cell holder 22 may be made of resin and is fitted into the case body 13 so as to be positioned therewithin (see FIG. 3). The cell holder 22 holds the battery cells 20 in such a state that the battery cells 20 are tired. The cell holder 22 includes five cylindrical tubular storage portions 23 that can receive the battery cells 20, respectively. The storage portions 23 are arranged in two upper and lower stages and are connected to each other in a staggered manner. More specifically, three of the storage portions 23 are arranged in the upper stage, and the remaining two of the storage portions 23 are arranged in the lower stage. The storage portions 23 in the upper stage and the storage portions 23 in the lower stage are staggered from each other. Each of the storage portions 23 of the upper stage is connected to its adjacent one or two of the storage portions 23 of the lower stage. The battery cells 20 are inserted into the storage portions 23, respectively, so as to be held in position therewithin. The battery cells 20 are electrically connected in series with each other by suitable leads, such as lead plates or lead wires (not shown).

For the purpose of explanation, the battery cell 20 positioned on the left side of the upper stage, the battery cell 20 positioned on the left side of the lower stage, the battery cell 20 positioned on the central side of the upper stage, the battery cell 20 positioned on the right side of the lower stage, and the battery cell 20 positioned on the right side of the upper stage will be hereinafter called as a first battery cell 20(1), a second battery cell 20(2), a third battery cell 20(3), a fourth battery cell 20(4) and a fifth battery cell 20(5), respectively.

As shown in FIGS. 2 and 4, a rectangular circuit board 25 elongated in forward and rearward directions is mounted on the cell bolder 22 so as to extend horizontally. A number of circuit elements 27 are mounted to the lower surface of the circuit board 25. As shown in FIGS. 2 to 4, a pair of right and left retainer frames 29 are formed on the cell holder 22 and are configured to be symmetrical with each other. Each of the retainer frames 29 has a straight base portion and a pair of parallel portions extending substantially perpendicular to the base portion from opposite ends of the base portion. The right and left retainer frames 29 are positioned so as to surround the right and left ends of the circuit board 25, respectively, so that the circuit board 25 is fitted between the retainer frames 29.

As shown in FIG. 4, a left charge/discharge terminal 31 and a right charge/discharge terminal 32 are disposed on the upper surface of the circuit board 25 (see also FIGS. 2 and 3). For example, the left charge/discharge terminal 31 may be a positive charge/discharge terminal and may be connected to a positive side connector of an electric wiring assembly including the battery cells 20. The right charge/discharge terminal 32 may be a negative charge/discharge terminal and may be connected to a negative side connector of the electric wiring assembly. The left and right charge/discharge terminals 31 and 32 are positioned to correspond to the slits 17 of the cover member 14 (see FIG. 2). Therefore, when the battery pack 10 is mounted to the power tool or the battery charger, positive and negative connecting terminals (not shown) of the power tool or the battery charger can be electrically connected to the charge/discharge terminals 31 and 32 via the slits 17.

The arrangement of the battery cells 20 will now be described in detail with reference to FIG. 6. For the convenience of explanation, the cell holder 22 is not shown in FIG. 6. As described previously, five battery cells 20(1) to 20(5) are used in this example. Three (20(1), 20(3) and 20(5)) of the battery cells 20 are arranged horizontally in the upper stage and the remaining two (20(2) and 20(4)) of the battery cells 20 are arranged horizontally in the lower stage. The battery cells 20 are tired in such a manner that each of the battery cells 20(1), 20(3) and 20(5) of the upper stage is positioned on the upper side of one or two of the battery cells 20(2) and 20(4). In other words, each of the battery cells 20 (other than the battery cells 20(1) and 20(5) positioned at the leftmost position and the rightmost position) is positioned to partly enter a valley-like space formed between the other two battery cells 20 positioned on its upper or lower side. This arrangement will be hereinafter called a “staggered tire arrangement.” In addition, the five battery cells 20 will be generically called a “battery cell group 20S.”

As described previously, each of the battery cells 20 has a cylindrical configuration having the diameter 20d of 18 mm and the axial length 20L of 75 mm (see FIG. 5). Therefore, in order to reduce the size of the battery pack 10, the battery cell group 208 may preferably have a width W of equal to or less than 72 mm (four times as the diameter 20d) and have a height H of equal to or less than 36 mm (twice the diameter 20d).

The upper three battery cells 20 or the first, third and fifth batter cells 20(1), 20(3) and 20(5) are opposed to the lower surface of the circuit board 25. In this example, the first and fifth battery cells 20(1) and 20(5) are positioned on opposite sides of the third battery cell 20(3).

The third battery cell 20(3) is displaced downwardly away from the circuit board 25 by a distance smaller than a radius (i.e., half the diameter 20d) of each battery cell 20. More specifically, as shown in FIG. 6, a center 20C of the third battery cell 20(3) is displaced downwardly from a straight line L by a distance X. The straight line L connects between centers 20C of the first battery cell 20(1) and the fifth battery cell 20(5). Here, the distance X is set to be smaller than half the radius (i.e., half the diameter 20d) of each battery cell 20. However, the distance X may preferably be larger than a protruding distance 27p of the circuit elements 27 from the lower surface of the circuit board 25. In connection with this arrangement, the second battery cell 20(2) and the fourth battery cell 20(4) are positioned not to contact with each other but are slightly spaced from each other in the left and right directions.

As noted above, in this example, the height H of the battery cell group 20S is set to be less than the twice of the diameter 20d of each battery cell 20. In addition, a distance D1 between the center 20C of the second battery cell 20(2) and the center 20C of the fourth battery cell 20(4) is set to be shorter than a distance D2 between the center 20C of the first battery cell 20(1) and the center 20C of the fifth battery cell 20(5).

With this arrangement, a valley-like space defined between the first battery cell 20(1) and the fifth battery cell 20(5) on the lower side of the circuit board 25 can be used as a space for receiving the circuit elements 27 that are mounted on the circuit board 25. Thus, the central third battery cell 20(3) does not interfere with the circuit elements 27, and therefore, it is possible to minimize the dead space.

Further, as shown in FIGS. 2 and 3, concave portions 34 are formed at corners between a bottom wall portion 13a and left and right side walls 13b of the case body 13 of the battery case 12. In this example, the left concave portion 34 is curved inwardly to have a shape like a stepped portion filling a valley-like space defined between the first battery cell 20(1) and the second battery cell 20(2). Similarly, the right concave portion 34 is curved inwardly to have shape like a stepped portion protruding into a valley-like space defined between the fourth battery cell 20(4) and the fifth battery cell 20(5).

According to the battery pack 10 described above, among the battery cells 20 positioned in the upper stage, the central third battery cell 20(3) positioned between the first and fifth battery cells 20(1) and 20(5) is displaced downwardly away from the lower surface of the circuit board 25 by the distance X that is smaller than the radius (half the diameter 20d) of each battery cell 20. Therefore, the space defined between the first battery cell 20(1) and the fifth battery cell 20(5) on the lower side of the circuit board 25 can be used as a mounting space for the circuit elements 27, so that the circuit board 25 has a minimum dead area that cannot be used for mounting the circuit elements 27. As a result, it is possible to increase an area of the circuit board 25 usable for mounting the circuit elements 27 without accompanying substantial increase of the size of the battery pack 10. In addition, because the usable area of the circuit board 25 can be increased, it is possible to increase the flexibility in designing the circuit board 25.

In particular, the size of the battery pack 10 having five battery cells 20 including three battery cells 20 in the upper stage and two battery cells in the lower stage can be minimized while it is possible to increase the usable area of the circuit board 25 for the circuit elements 27. Because the five battery cells 20 are arranged symmetrically in left and right directions, it is possible to substantially uniformly cool the battery cells 20, for example, by the flow of air flowing through inside of the battery pack 10.

Furthermore, because the concave portions 34 are formed at corners between the bottom wall portion 13a and the left and right side walls 13b of the case body 13 of the battery case 12, it is possible to reduce the width (the size in left and right directions as viewed in FIG. 2) of the bottom wall portion 13a. Therefore, it is possible to further reduce the size of the battery pack 10. Although each of the concave portions 34 is curved inwardly to have a shape like a stepped portion in this example, it may have a shape like an inclined flat plate or an arcuate curved shape.

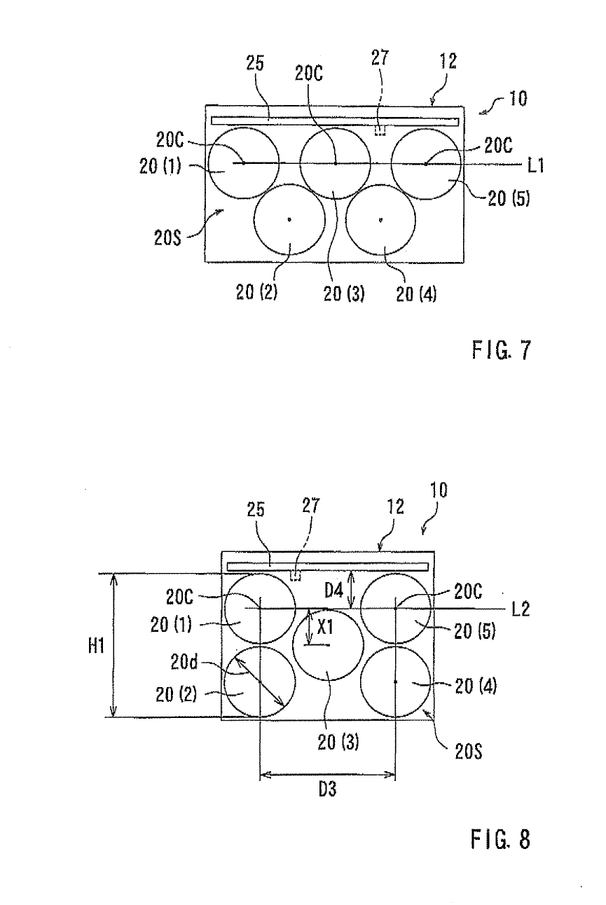

The usable area of the circuit board 25 of the battery pack 10 of this example will be explained further in comparison with first to fourth comparative examples shown in FIGS. 7 to 10. In FIGS. 7 to 10, like members are given the same reference signs as the first example.

### First Comparative Example

In the comparative example shown in FIG. 7, three battery cells 20(1), 20(3) and 20(5) opposed to the circuit board 25 are arranged on a straight line Li connecting between the centers 20C of these battery cells. In this case, valley-like spaces defined between the first battery cell 20(1) and the third battery cell 20(3) and between the third battery cell 20(3) and the fifth battery cell 20(5) on the lower side of the circuit board 25 may serve as usable spaces for mounting the circuit elements 27. However, the space between the circuit board 25 and the central third battery cell 20(3) cannot be used for mounting the circuit elements 27. In other words, the third battery cell 20(3) produces a dead space, and therefore, the usable area of the circuit board 25 is reduced. It may be possible to increase distances between the circuit board 25 and the battery cells 20(1), 20(3) and 20(5) for increasing the usable area of the circuit board 25, However in such a case, the height of the battery pack 10 may be increased, and eventually, the size of the battery pack 10 may be increased.

In contrast, according to the battery pack 10 of the first example, the central battery cell 20(3) is displaced downwardly away from the circuit board 25 by the distance X that is smaller than the radius of the battery cells 20. This arrangement enables to reduce the dead area of the circuit board 25 without substantially increasing the size of the battery pack 10.

### Second Comparative Example

In the second comparative example shown in FIG. 8, the second battery cell 20(2) is arranged directly below the first battery cell 20(1). Similarly, the fourth battery cell 20(4) is arranged directly below the fifth battery cell 20(5). The third battery cell 20(3) is positioned within a valley-like space defined between the first battery cell 20(1) and the second battery cell 20(2) and also within, a valley-like space defined between the fourth battery cell 20(4) and the fifth battery cell 20(5). In this connection, the fourth battery cell 20(4) and the fifth battery cell 20(5) as well as the first battery cell 20(1) and the second battery cell 20(2) are shifted toward the center of the battery pack 10.

Therefore, the center 20C of the third battery cell 20(3) is shifted downward by a distance Xl from a straight line 12 connecting between the centers 20C of the first batter cell 20(1) and the fifth battery cell 20(5). Here, the distance X1 is larger than the radius (half the diameter 20d) of each battery cell 20. In this case, a distance D3 between the centers 20C of the first battery cell 20(1) and the fifth battery cell 20(5) becomes smaller than the distance D2 (see FIG. 6) provided in the case of the first example. This may lead to reduce the usable area of the circuit board 25 for mounting the circuit elements 27. In addition, the arrangement of this comparative example is not preferable because a distance D4 between the circuit board 25 and the third battery cell 20(3) is too long and because a height HI of the battery cell group 28 may exceed twice the diameter 20d of each battery cell 20.

### Third Comparative Example

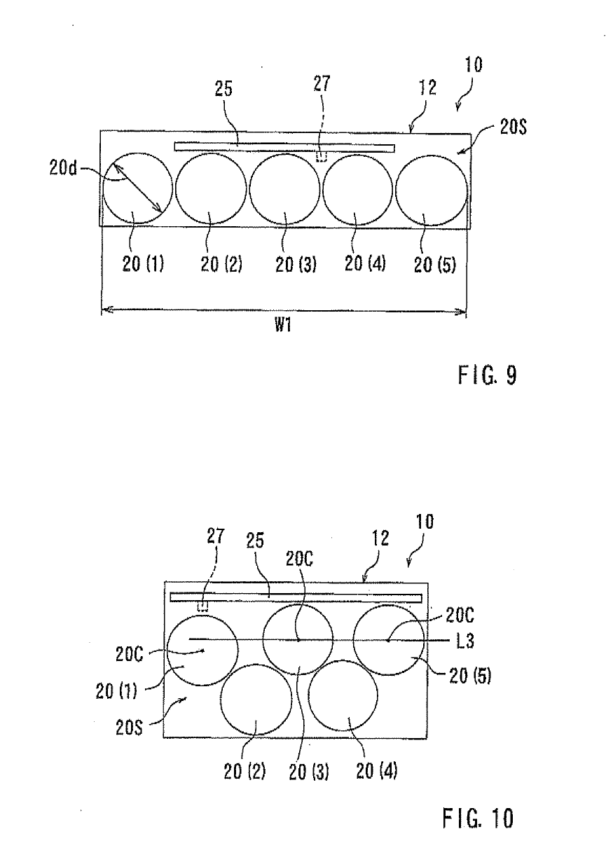

In the third comparative example shown in FIG. 9, five battery cells 20(1) to 20(5) are arranged horizontally in line. In this case, valley-like spaces defined between the second and third battery cells 20(2) and 20(3) and between the third and fourth battery cells 20(3) and 20(4) on the lower side of the circuit board 25 can be used as spaces for receiving the circuit elements 27. However, due to the presence of the central third battery cell 20(3), a total space usable for receiving the circuit elements 27 is reduced. In other words, a usable area of the circuit board 25 is reduced. In addition, the arrangement of the third comparative example is not preferable because a width W1 of the battery cell group 20S may exceed four times as the diameter 20d of each battery cell 20.

### Fourth Comparative Example

In the fourth comparative example shown in FIG. 10, the arrangement of the first comparative example shown in FIG. 7 is modified such that the third battery cell 20(3) is shifted downwardly from a straight line L3 connecting between the centers 20C of the third battery cell 20(3) and the fifth battery cell 20(5). In this case, the space positioned on the left side of the third battery cell 20(3) can serve as a usable space for receiving the circuit elements 27. However, a total usable area is still small than in the case of the first example shown in FIG. 6. In addition, the five battery cells 20 are asymmetric in the firth and left directions. Therefore, it is difficult to uniformly cool the battery cells 20 by the flow of air.

### Conclusion of Comparison

As described above, the battery pack 10 of the first example having the battery cells 20 arranged as shown in FIG. 6 is advantageous over the first to fourth comparative examples shown in FIGS. 7 to 10 in that the usable area of the circuit board 25 for mounting the circuit elements 27 can be increased without accompanying substantial increase of the size of the battery pack 10.

### Second Example

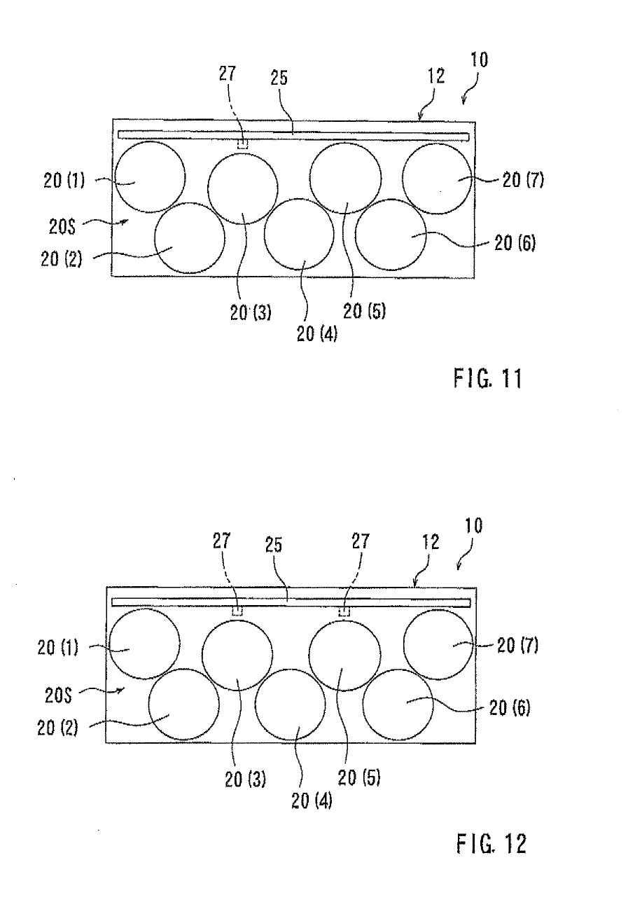

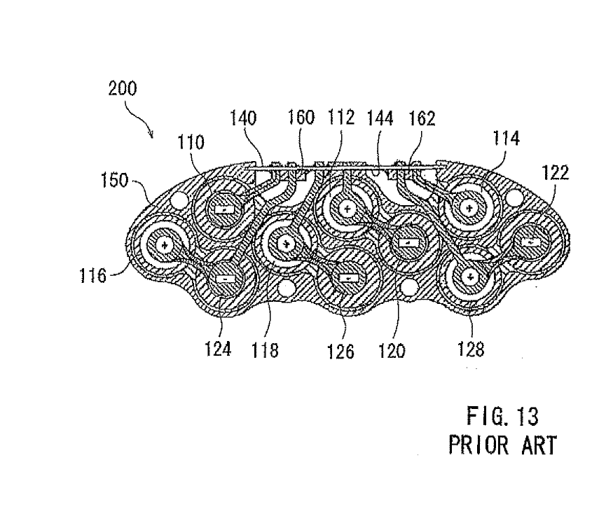

A second example will now be described with reference to FIG. 11. This example is a modification of the first example, and therefore, like members are given the same reference signs as the first example and the description of these members will not be repeated. In this example, sixth and seventh battery cells 20(6) and 20(7) are added to the first to fifth battery cells 20(1) to 20(5), so that seven battery cells 20 in total are provided. The sixth and seventh battery cells 20(6) and 20(7) are positioned on the right side of the fourth and fifth battery cells 20(4) and 20(5), respectively. Therefore, in this example, four battery cells 20(1), 20(3), 20(5) and 20(7) are positioned on the side of the circuit board 25.

According to this example, the battery pack 10 has seven battery cells 20(1) to 20(7) including three battery cells 20(1), 20(3) and 20(5) positioned on the side of the circuit board 25 in the upper stage and two battery cells 20(2) and 20(4) positioned in the lower stage and arranged in a manner staggered from the battery cells 20(1), 20(2) and 20(5). Therefore, also with this arrangement, it is possible to increase the usable area of the circuit board 25 without accompanying substantial increase of the size of the battery pack 10, In this example, the first and seventh, battery cells 20(1) and 20(7) are positioned at leftmost and rightmost positions, respectively, and the third battery cell 20(3) and the fifth battery cell 20(5) are positioned between the leftmost and rightmost battery cells 20(1) and 20(7).

### Third Example

A third example will now be described with reference to FIG. 12. This example is a modification of the second example shown in FIG. 11 and is different from the second example in that the fifth battery cell 20(5) is shifted downward as in the case of the third battery cell 20(3). With this arrangement, it is possible to use a valley-like space between the first battery cell 20(1) and the seventh battery cell 20(7) as a space for receiving any of the circuit elements 27.

### Other Possible Examples

Although the number of the battery cells 20 in the above embodiments are five and seven, the number of the battery cells 20 may not be limited to these numbers.

1. A battery pack comprising:
a battery case;
a circuit board disposed within the battery case and having circuit elements mounted thereon;
a battery cell group including a plurality of cylindrical battery cells having a same radius and diameter and disposed within the battery case, the battery cells being staggered from each other so that the battery cell group has a plurality of battery cell stages including a first battery cell stage positioned on the side of the circuit elements of the circuit board and a second battery cell stage positioned adjacent to the first stage on the side away from the circuit board, wherein:
the first battery cell stage includes at least three battery cells including a first battery cell, a second battery cell and a third battery cell;
the first and second battery cells are positioned at opposite ends of the first battery cell stage;
the third battery cell is positioned between the first and the second battery cell; and
the third battery cell is displaced in a direction away from the circuit board relative to the first and second battery cells by a distance smaller than the radius of the battery cells.

2. The battery pack as in claim 1, wherein the second battery cell stage includes at least two battery cells.

3. The battery pack as in claim 2, wherein the first battery cell stage includes three battery cells and the second battery cell stage includes two battery cells, so that the battery cell group includes five battery cells in total.

4. The battery pack as in claim 1, wherein the battery case includes a bottom wall and first and second side walls opposite to each other, wherein an inwardly oriented concave portion is formed at each of corner portions between the bottom wall and the first and second side walls.

5. The battery pack as in claim 2, wherein the first battery cell stage includes four or more battery cells.

6. The battery pack as in claim 2, wherein the second battery cell stage includes three or more battery cells.

7. The battery pack as in claim 1, further comprising a cell holder configured to hold the battery cell group within the battery case.

8. The battery pack as in claim 2, wherein the battery cell group has a height in a direction perpendicular to a surface of the circuit board, and the height is less than the battery cell diameter multiplied by the number of the battery cell stages.

9. The battery pack as in claim 1, wherein the third battery cell is spaced from the circuit board by a distance, so that the third battery cell does not interfere with the circuit elements of the circuit board.

10. A battery pack comprising:
a battery case;
a circuit board disposed within the battery case and having circuit elements mounted thereon;
a battery cell group including a plurality of cylindrical battery cells and disposed within the battery case, the battery cells being staggered from each other so that the battery cell group has a plurality of battery cell stages including a first battery cell stage positioned on the side of the circuit elements of the circuit board and a second battery cell stage positioned adjacent to the first stage on the side away from the circuit board, wherein:
the first battery cell stage includes at least three battery cells including a first battery cell, a second battery cell and a third battery cell;
the first and second battery cells are positioned at opposite ends of the first battery cell stage;
the third battery cell is positioned between the first and the second battery cell; and
the third battery cell is spaced from the circuit board by a distance, so that the third battery cell does not interfere with any of the circuit elements of the circuit board.

11. The battery pack as in claim 10, wherein the third battery cell is displaced from the first and second battery cells in a direction away from the circuit board.
